(19) United States
(12) Patent Application Publication
(10) Pub. No.: US 2009/0171853 A1
(43) Pub. Date: Jul. 2, 2009

(54) Method and System for Hosting an In-Store Electronic Auction

(75) Inventors: Christos John Georgiou, Scarsdale, NY (US); Bernice Ellen Rogowitz, Ossining, NY (US); Myron Flickner, San Jose, CA (US)

Correspondence Address: CAHN & SAMUELS, LLP, 1100 17th STREET, NW, SUITE 401, WASHINGTON, DC, 20036, US

(73) Assignee: International Business Machines Corporation, Armonk, NY (US)

(21) Appl. No.: 11/967,554

(22) Filed: Dec. 31, 2007

(51) Int. Cl. G06Q 30/00

(52) U.S. Cl. 705/80

(57) ABSTRACT

A system for hosting an in-store electronic auction including a plurality of shoppers including a store server capable of synchronizing with handheld portable devices within a predetermined geographic area, a plurality of customers having portable electronic devices. The portable electronic devices are capable of synchronizing with the store server, such that the plurality of customers can individually send and receive auction information therethrough, as well as an inventory of products within the predetermined geographic area from which a customer can shop. The store server identifies the shoppers in the predetermined geographical area through the portable electronic device, and determines a shopper's eligibility to participate in the auction. If the shopper is determined to be eligible to participate, the system synchronizes the shopper's portable electronic device to the store server. Upon receiving an offer for the purchase of an item from the inventory of products from a first eligible shopper, placed through the shopper's portable electronic device, the system determines if the first shopper's offer for the item in inventory is above a predetermined price, if the offer from the first shopper is above a predetermined price, system approves and authorizes the sales transaction. If the offer from the first shopper is not above a predetermined price the server notifies other eligible shoppers from the plurality of an auction for the item in inventory through the eligible shoppers' portable electronic device. The system then receives offers for the purchase of the item from the eligible shoppers of the plurality through the eligible shoppers' portable electronic device.

### I. FIELD OF THE INVENTION

This invention relates in general to the field of computer systems and retail and electronic-commerce and in particular to the field of hosting electronic or on-line auctions.

### II. DESCRIPTION OF THE PRIOR ART

Merchants use different methods to entice customers into their stores. They offer merchandise on sale and place ads in various media, such as newspapers, television, radio, internet, etc. They offer sale coupons in newspapers, magazines, or at the door. They have 15 or 30 minute sales on certain items for customers already in the store. In general, a lot of effort is made by merchants to bring customers into their stores and make their shopping experience a pleasant one, so that they make purchases and, most importantly, come back. One big competitor of traditional stores is on-line shopping, as it allows customers to purchase goods without leaving the leisure of their home.

The Internet has enabled rapid growth of on-line commerce. On-line retailers such as amazon.com, etc. have been seeing increased sales volumes. Electronic Auctions are now widespread and very common. Interactive transactions via on-line auctions carried out at eBay, Yahoo! or similar on line auction sites have experienced significant growth. While the traditional way of shopping at stores is not likely to go away soon, there is value in introducing new technologies that would enhance the in-store shopping experience and increase store sales.

It would therefore be desirable to combine the convenience of electronic or on-line commerce with traditional in-store commerce to generate interest, excitement and sales. The terms “customer” and “shopper” are used interchangeably through this text.

### III. SUMMARY OF THE INVENTION

A method for hosting an in-store electronic auction including a plurality of shoppers comprising identifying the shoppers in a predetermined geographical area, and determining a shopper's eligibility to participate in the auction. If the shopper is determined to be eligible synchronizing the shopper's portable electronic device to a store server. The method also includes receiving an offer for the purchase of an item in inventory from a first eligible shopper, placed through the shopper's portable electronic device and determining if a first shopper's offer for the item in inventory is above a predetermined price.

If the received offer is above a predetermined price, authorizing the sales transaction. If the received offer is not above a predetermined price the disclosed method also includes notifying other eligible shoppers from the plurality of an auction for the item in inventory through the eligible shoppers' portable electronic device and receiving offers for the purchase of the item from the eligible shoppers of the plurality through the eligible shoppers' portable electronic device.

A system for hosting an in-store electronic auction including a plurality of shoppers comprising a store server capable of synchronizing with handheld portable devices within a predetermined geographic area, and a plurality of customers having portable electronic devices. The portable electronic devices are capable of synchronizing with the store server, such that the plurality of customers can individually send and receive auction information threrethrough. The system also comprises an inventory of products within the predetermined geographic area from which a customer can shop.

The store system identifies the shoppers in the predetermined geographical area through the portable electronic device, and determines a shopper's eligibility to participate in the auction and synchronizes the shoppers' portable electronic device to the store server. When the system receives an offer for the purchase of an item from the inventory of products from a first eligible shopper, placed through the shopper's portable electronic device, the system determines if the first shopper's offer for the item in inventory is above a predetermined price.

If the offer from the first shopper is above a predetermined price, it authorizes the sales transaction. If the offer from the first shopper is not above a predetermined price the system notifies other eligible shoppers from the plurality of an auction for the selected item in inventory through the eligible shoppers' portable electronic device. The system receives offers for the purchase of the item from the eligible shoppers of the plurality through the eligible shoppers' portable electronic device.

A computer program product comprising a computer useable medium including computer usable program code for hosting an in-store electronic auction, the computer program product includes a computer usable program code for identifying the shoppers in a predetermined geographical area, and computer usable program code for determining a shopper's eligibility to participate in the auction. The computer program product also includes computer usable program code for synchronizing a shoppers portable electronic device to a store server and computer usable program code for receiving an offer for the purchase of an item in inventory from a first eligible shopper, placed through the shopper's portable electronic device as well as computer usable program code for determining if a first shopper's offer for the item in inventory is above a predetermined price.

If the received offer is above a predetermined price the computer usable program product will authorize the sales transaction. If the received offer is not above a predetermined price, the program product uses computer usable program code for notifying other eligible shoppers from the plurality of an auction for the item in inventory through the eligible shoppers' portable electronic device. The computer program product further employs computer usable program code for receiving offers for the purchase of the item from the eligible shoppers of the plurality through the eligible shoppers' portable electronic device.

### IV. BRIEF DESCRIPTION OF THE DRAWINGS

In order to describe the manner in which the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates a block diagram of the basic in-store electronic auction system.

FIG. 2 illustrates a block flow diagram of an example embodiment of the basic in-store electronic auction system up to the initiation of an offer for purchase.

FIG. 3 illustrates a block diagram of the communications between the handheld portable devices and the store server.

FIG. 4 illustrates a block flow diagram of an example embodiment of the in-store auction process with a counter offer form the store server.

FIG. 5 illustrates a block flow diagram of an example embodiment of the auction process once an auction has been initiated.

### V. DETAILED DESCRIPTION

It will be understood that each block of the flowchart illustrations and block diagrams and combinations of those blocks can be implemented by computer program instructions and/or means.

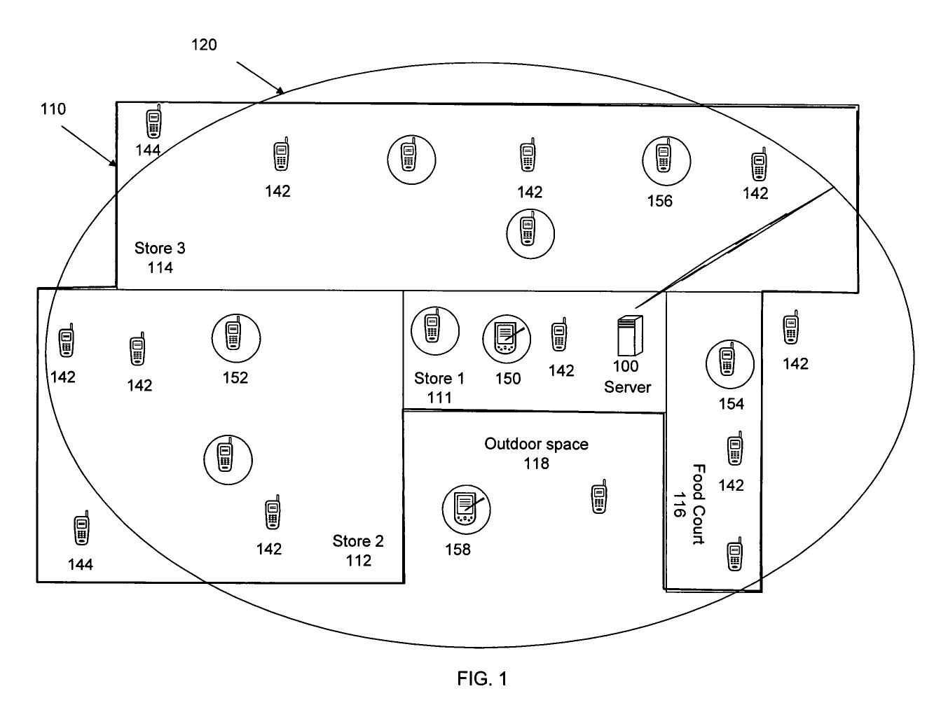

Referring now to FIG. 1 which shows a block diagram of an example embodiment of the electronic in-store auction system. The disclosed system for hosting an in-store electronic auction features a plurality of shoppers and at least one store server 100 capable of communicating through a wireless connection with handheld portable devices 142, 144, 150, 152, 154, 156 and 158 within a predetermined geographic area, and a plurality of customers possessing said portable electronic devices. The portable electronic devices 142, 144, 150, 152, 154, 156 and 158 are capable of communicating and synchronizing with the store server, such that the plurality of customers can individually send and receive auction information to and from the server therethrough.

The connection between the portable electronic device and the store server employs standard connection methods—i.e., mobile networks such as GSM, Bluetooth or 802.11. The connection between the store server and the customers portable electronic device is preferably initiated automatically on the customers entry to the store using various store entry identification methods such as an RFID tag on a phone or fob, interaction at a kiosk such as swiping a loyalty/smart card, however the connection may be disabled completely or require manual initiation at the customer's discretion.

In the example embodiment shown in FIG. 1 various shoppers are denoted by their portable electronic devices 142, 144, 150, 152, 154, 156 and 158, along with their proximate relation to in-store auction server 100. The customer has access to an inventory of products (not shown) within the predetermined geographic area from which a customer can shop.

In-store auction server 100 is able to communicate with and/or otherwise synchronize with portable electronic devices, such as cell phones, pagers or PDA's within a predetermined service area 120. Generally the transmission range/service area will not extend beyond a physical store or shopping area (mall).

In the embodiment shown in FIG. 1, the geographical area in which the system operates encompasses a shopping mall 110 having a plurality of stores 111, 112, a food court 114 and the adjoining outdoor space 118. Server 100, is physically located in a store (111) centrally located in the shopping area, however the physical location of the server is not limiting to the invention. Server 100 may be disposed in any location from which it is capable of wireless communication, information transfer and/or otherwise synchronization with the portable electronic device 142, 150, 152, 154, 156 and 158 of a shopper within the predetermined service area 120.

The store system identifies the shoppers in the predetermined geographical area through a portable electronic device 142, 144, 150, 152, 154, 156 and 158, and determines a shopper's eligibility to participate in the auction and synchronizes the shoppers portable electronic device 150, 152, 154, 156 and 158 to the store server 100 if it is determined that the shopper is eligible to participate. If the shopper is eligible to participate, the shopper can make an unsolicited offer to purchase an item from the inventory at a price desired by the shopper, by submitting an offer to the store server through his or her portable electronic device.

As shown in FIG. 1, portable electronic devices 150, 152, 154, 156 and 158 are within the physical service area 120 of server 100 and belong to shoppers who have been determined to be eligible to initiate or otherwise participate in an in-store auction are denoted by the small circles. These devices are synchronized with the server 100, and can chose to take part in the auction process.

The portable electronic device 142 is within the range of the predetermined service area but belong to shoppers who are not cleared or otherwise eligible to participate in the auction. The portable electronic devices 144 are those that may have been in range at one time but have strayed beyond the service area are or otherwise outside the service are ignored by the server.

In one embodiment the shopper will enter a SKU number or other reference number for a product, along with a proposed price and submit the “bid” to the store server 100. When the system receives an offer for the purchase of an item from the inventory of products from a first eligible shopper, through the shopper's portable electronic device, the system initiates an auction on that particular item allowing other registered shoppers 152, 154, 156 and 158 to bid on the item.

In a preferred embodiment bids have time limits of less than an hour, however the time limit could extend over many hours, or even days. As the customers move about the store shopping, updates on the auction prices are downloaded to the screen of his or her handheld device. Base on this updated information the participants can then adjust their bids accordingly. When the bidding ends, the winning customer takes the item to the checkout counter, verifies the bidding price (which can be charged automatically to his credit card) and checks out. During the checkout process the customer is reminded about any open auction they are participating in and potentially a special offer is presented to close the deal.

In another preferred embodiment the shopper will enter a SKU number or other reference number for a product along with a price and submit the “bid” to the store server 100. When the system receives an offer for the purchase of an item from the inventory of products from a first eligible shopper, placed through the shopper's portable electronic device 150, the system determines if the first shopper's offer for the item in inventory is above a predetermined price.

If the offer from the first shopper is above a predetermined price, the system authorizes the sales transaction. If the offer from the first shopper is not above a predetermined price the system notifies other eligible shoppers from the plurality of an auction for the selected item in inventory through the eligible shoppers' portable electronic device. The system receives offers for the purchase of the item from the eligible shoppers of the plurality through the eligible shoppers' portable electronic device. Another variation of this method is to offer this process to the mall or a collection of stores in shopping complex. In this case multiple retailers could be auctioning items to consumers in the mall area.

In yet another embodiment of this scheme is for the customer to select an item he wants to bid for, enter it in the system via his handheld device (the customer is already logged-on in the auction system) and make an offering bid. The system can then, either reject the bid, accept the bid, or counter-bid with a price that is entered as an auction item (for others to bid on). This would be similar to a Middle Eastern bazaar, where the customer makes an offer to the merchant and engages in a price negotiation.

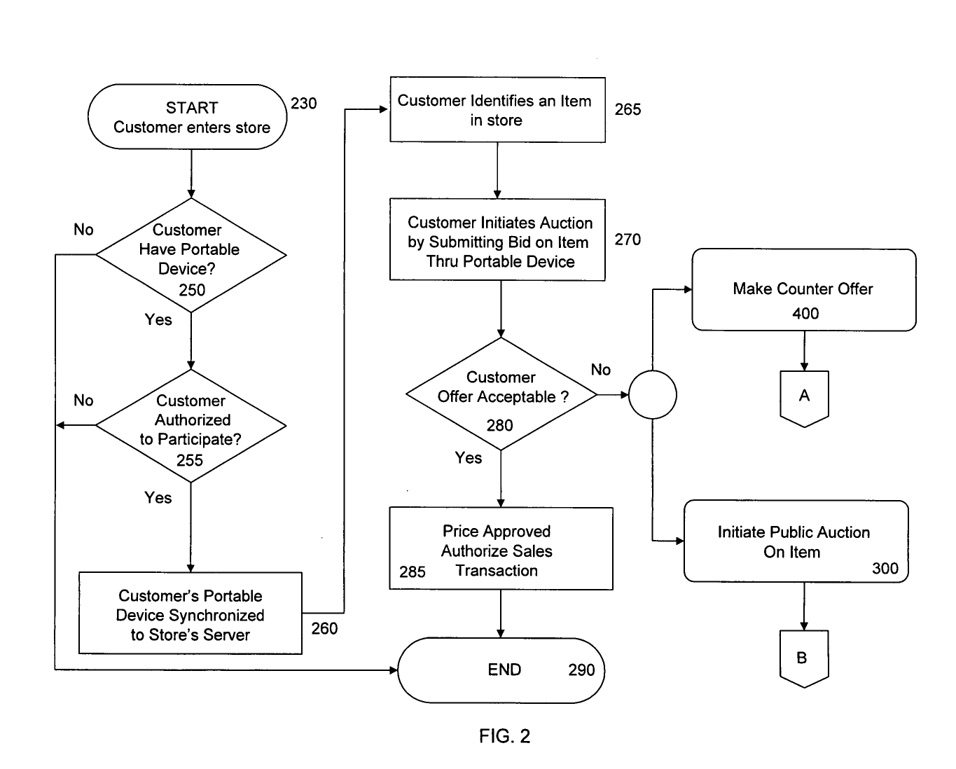

FIG. 2 illustrates a flow diagram of an example embodiment of the basic in-store electronic auction system. The process includes identifying the shoppers in a predetermined geographical area, and determining a shopper's eligibility to participate in the auction. This process is generally initiated when the customer enters the store 230 or otherwise brings a portable electronic device that can be identified by the store server within range of the store server 250. Next, the store server 100 will determine if the shopper is authorized to participate in the store's electronic auction activities 255.

When the shopper is determined to be eligible, the shopper's personal portable electronic device is synchronized to a store server 260. During this period, the customer is going about his or her business in the store, just like any other shopper. Once the customer identifies an item in the store that he or she is interested in 265, the customer can submit an offer or “bid” on that particular item 270 through the customers portable electronic device.

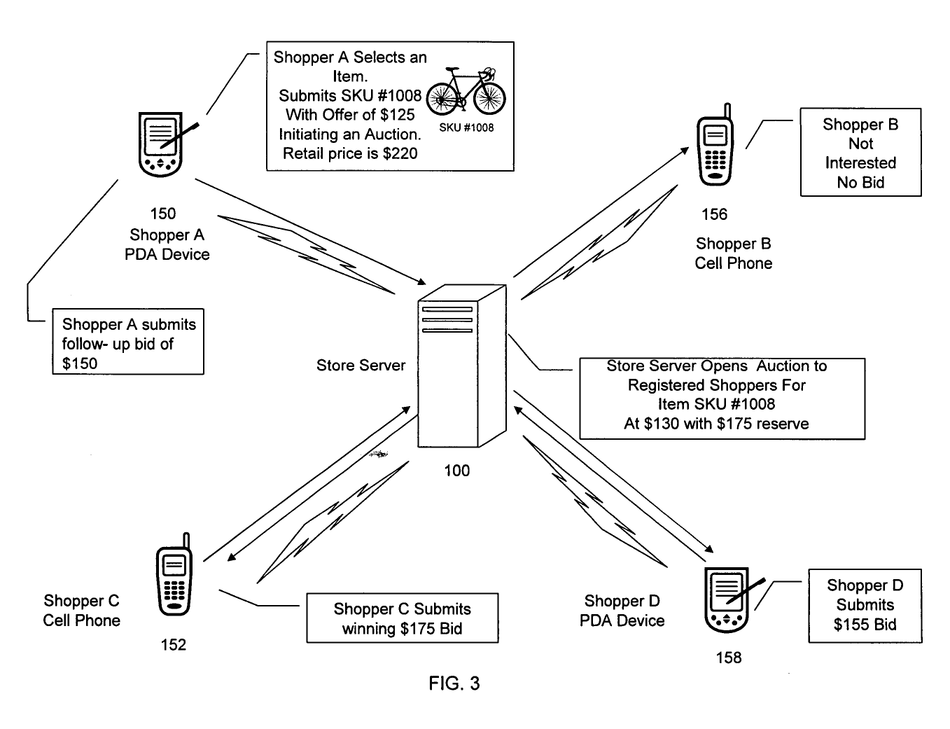

Referring now to FIG. 3 with continued reference to FIG. 1 and FIG. 2, Customer A 150 selects an item 399 from the store inventory. Customer A submits an offer or “bid” on that particular item through her the portable electronic device 270.

In this particular example Customer A has identified an item in the store, for purposes of example a bicycle, that she wants, but she wishes to pay less that the $220 price with which the item is marked. She enters the SKU number for the bicycle into her cell phone, PDA or other portable electronic device 150, and submits an offer to purchase the item at $125, to the store server 100.

Customer A's offer places that item in play, initiating the auction activity on that particular item. The store server 100 receives the customers offer for the purchase of an item in inventory from this first eligible shopper, placed through the shopper's portable electronic device 150 and determines if the shopper's offer for the item is above a predetermined price.

The server then determines if the customer's offer is acceptable for that particular item 280. If the received offer is above a predetermined price, the server authorizes the sales transaction 285. While this example embodiment contemplates only price in determining the viability of the customer's offer, other criteria may also be evaluated such as the customer's shopping history, coupons, package discounts or other appropriate criteria.

If the offer received by the server is not above a predetermined price, the server may transmit a counter offer to the customer through the cell phone, PDA or other portable electronic device 150 in response to the initiating offer 400. The counter offer may be for a higher price, a package deal, for substitute merchandise or propose some other appropriate condition.

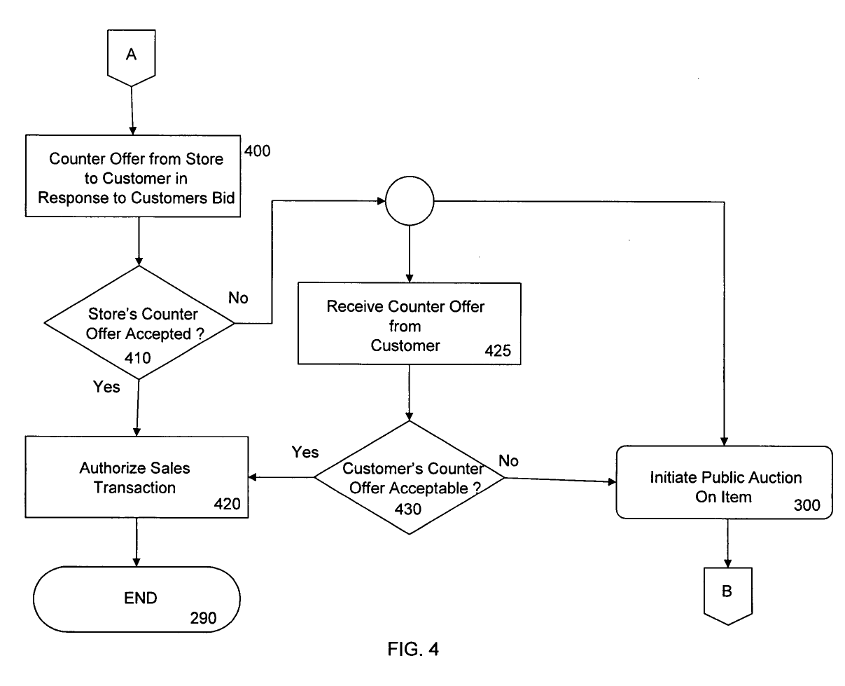

FIG. 4 illustrates a block flow diagram of an example embodiment of the in-store auction process featuring a counter offer form the store server. Upon receiving an offer initiating the process from Customer A, the store server evaluates Customer A's offer. If Customer A's offer is determined to be below the store's target price, the store may transmit a counter offer to the Customer A, through that customer's portable electronic device. The store then determines if the offer has been accepted by the customer 410. If the offer is accepted by the customer, the server authorizes the transaction 420.

If the store's counter offer is rejected, the server may receive and evaluate a counter offer from the initiating seller 425, or simply notify other eligible shoppers from the plurality of an auction for the item 300 through the eligible shoppers' various portable electronic devices 152, 154, 156 and 158.

If the initiating customer 150 submits a counter offer the store server will evaluate the customers counter offer 430. If the offer received from the initiating customer is not above a predetermined price or otherwise meet the store's requirements the server may respond by notifying other eligible shoppers from the plurality of an auction for the item in inventory 300 through the eligible shoppers' portable electronic device 150, 152, 154, 156 and 158.

In the resulting auction the server receives offers for the purchase of the item from the eligible shoppers of the plurality through the eligible shoppers' portable electronic device 300.

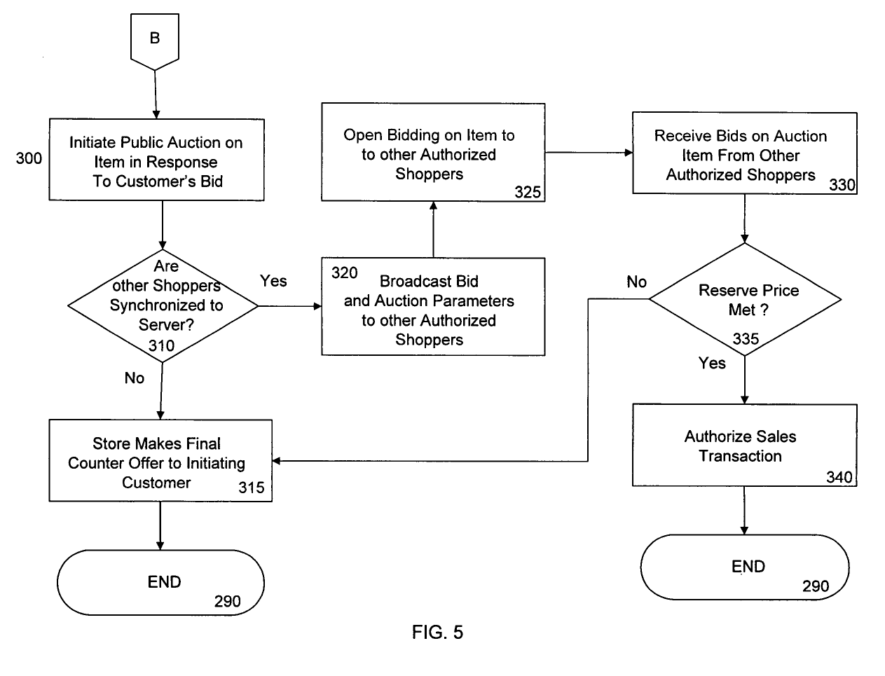

Referring now to FIG. 5 which illustrates a flow diagram of an example embodiment of the auction process once an auction has been initiated 300, by Customer A, who submits a bid on an item selected from the store inventory via her PDA device 150.

An auction generally requires a plurality of participants, so prior to opening an auction to other eligible shoppers, the system determines if there are other eligible shoppers in range and synchronized to the server 310. In the event that there are no additional shoppers within range the store may make a final counter offer 315 to the initiating customer or simply terminate the negotiations.

If the system determines that there are additional eligible shoppers in range and synchronized to the server 152, 154, 156 and 158, the system broadcast the bid and auction parameters to other shoppers as authorized participants 320. The bidding is then opened to all authorized shoppers on the item brought into play by the initiating customer 325.

The server receives bids on the auction item from other authorized shoppers 330, and determines if the reserve price is met, or if the other requirements for the auction are satisfied 335. If so, the system authorizes the transaction 340. If the store's requirements are not satisfied, the store may make a final offer to the initiating bidder 315 or the high bidder on the item.

Referring now to FIG. 3 which shows an example embodiment of an in-store auction, shopper A is physically in a store employing an in-store auction system and sees an item that interests her. She has a portable PDA device 150 that synchronizes with the store server 100. The server determines her to be eligible to participate in the in-store auction process. The item that interests shopper A is a bicycle that she has spotted in the inventory of the host store, with a tag indicating a price of $220. Shopper A enters the SKU# into her PDA or some other number identifying the product, as well as an offer price of $125, and submits her offer to the store's server, initiating the auction process for the identified item.

Store server has also identified other shoppers via their portable electronic devices, cell phones, PDA, pagers . . . etc., who are in the store or have been in the store at some point during the day, and who are currently in range of the serve and are also synchronized thereto. These shoppers are also eligible to participate in an in-store auction.

The store server receives the offer from shopper 1 on the bicycle, and determines that the offer by shopper A is below a predetermined price for that particular item. The predetermined price is $175 and a sales transaction will not be approved if the bid or offer is below that threshold.

The store's server opens the auction to the registered shoppers for the bicycle at $130 and sets a reserve price of $175, noticing the auction and receiving bids through each of the registered shopper's portable electronic devices, 150, 152, 156 and 158. Shopper B, 156, shopper C, 152, and shopper D, 158, need not be physically in the store, but they must be in range of the server, which means in the general geographic area of the store.

Referring again to FIG. 1 with continued reference to FIG. 5, each participating shopper is physically within area 120 covered by the server 100. The geographical area covered by the auction 120 is shown to cover the majority of the physical mall complex. In the example embodiment illustrated in FIG. 1, each portable device within the auction area is not eligible to participate in the auction. Only the devices shown having a circle are authorized to participate in the in-store auction. Shopper B 156 is in a different store now, but his device is still synchronized with the Store 1's server 100. Similarly shopper C, 152 and shopper C, 158 are no longer physically within-store 1, yet they are still in the mall area and are in communication with the store 1 server and therefore can receive and send, auction information to and from the store 1 server.

When the store 1 server opens the auction, each eligible shopper is notified of the auction and bids are solicited. In the example embodiment of FIG. 5, shopper 1 submits a follow up bid of $150 through her PDA 150. This information is transmitted to the server and the server displays this bid to the other participants as in a traditional electronic auction, however the interface is a potable electronic device. This price is below the reserve desired, so the store will continue the auction. Shopper B, is not interested in bidding but monitors the auction nonetheless, receiving periodic updates of the auction progress. Shopper D decides that he is interested in the bicycle also and submits a $155 bid via his PDA device, 158. This bid is also lower that the reserve so the auction continues. Shopper C has been monitoring this auction through the updates sent to his cell phone and submits a bid of $175 through his cell phone, 152. This bid is accepted by the server and Shopper C is authorized to purchase the bicycle for $175. This transaction may be performed through the cell phone or the Shopper C may perform the checkout in the physical store when he picks up the bicycle.

The disclosed invention can take the form of an entirely hardware embodiment, an entirely software embodiment or an embodiment containing both hardware and software elements. In at least one embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory, (CD-ROM), compact disk-read/write (CD-R/W) and DVD.

A data processing system suitable for storing and/or executing program code will include at least one processor coupled directly or indirectly to memory elements through a system bus. The memory elements can include a local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

In yet another example embodiment the invention takes the form of a computer program product having a computer useable medium including computer usable program code for hosting an in-store electronic auction, the computer program product includes a computer usable program code for identifying the shoppers in a predetermined geographical area, and computer usable program code for determining a shopper's eligibility to participate in the auction. The computer program product also includes computer usable program code for synchronizing a shoppers portable electronic device to a store server and computer usable program code for receiving an offer for the purchase of an item in inventory from a first eligible shopper, placed through the shopper's portable electronic device as well as computer usable program code for determining if a first shopper's offer for the item in inventory is above a predetermined price.

If the received offer is above a predetermined price the computer usable program product will authorize the sales transaction. If the received offer is not above a predetermined price, the program product uses computer usable program code for notifying other eligible shoppers from the plurality of an auction for the item in inventory through the eligible shoppers' portable electronic device. The computer program product further employs computer usable program code for receiving offers for the purchase of the item from the eligible shoppers of the plurality through the eligible shoppers' portable electronic device.

Although specific example embodiments have been illustrated and described herein, those of ordinary skill in the art appreciate that other variations, aspects, or embodiments may be contemplated, and/or practiced without departing from the scope or the spirit of the appended claims.

What is claimed is:

1. A method for hosting an in-store electronic auction including a plurality of shoppers comprising:
identifying the shoppers in a predetermined geographical area,
determining a shopper's eligibility to participate in the auction,
synchronizing a shoppers portable electronic device to a store server,
receiving an offer for the purchase of an item in inventory from a first eligible shopper, placed through said shopper's portable electronic device,
determining if a first shopper's offer for the item in inventory is above a predetermined price,
if the received offer is above a predetermined price, authorizing the sales transaction;
if the received offer is not above a predetermined price;
notifying other eligible shoppers from the plurality of an auction for said item in inventory through said eligible shoppers' portable electronic device.

2. The method of claim 1 further comprising the step of making the shopper a counter offer through said synchronized portable electronic device, if the received offer is not above a predetermined price.

3. The method of claim 1 further comprising the step of receiving offers for the purchase of said item from the eligible shoppers of the plurality through said eligible shoppers' portable electronic device.

4. The method of claim 1 further comprising authorizing the sales transaction with said first shopper if no offer is received for the purchase of said item from the eligible shoppers of the plurality above a predetermined price.

5. The method of claim 1 further comprising recording the customers identity, item information, offer and transaction information in a storage medium for future use.

6. A system for hosting an in-store electronic auction including a plurality of shoppers comprising:
a store server capable of synchronizing with handheld portable devices within a predetermined geographic area;
a plurality of customers having portable electronic devices, said portable electronic devices capable of synchronizing with said store server, such that said plurality of customers can individually send and receive auction information threrethrough;
an inventory of products within said predetermined geographic area from which a customer can shop;
wherein said store server identifies the shoppers in said predetermined geographical area through said portable electronic device, and determines a shopper's eligibility to participate in the auction, synchronizes said shoppers portable electronic device to the store server, receives an offer for the purchase of an item from said inventory of products from a first eligible shopper, placed through said shopper's portable electronic device, determines if said first shopper's offer for the item in inventory is above a predetermined price,
if said offer from said first shopper is above a predetermined price, authorizing the sales transaction;
if said offer from said first shopper is not above a predetermined price;
notifying other eligible shoppers from the plurality of an auction for said item in inventory through said eligible shoppers' portable electronic device.

7. The system of claim 6 wherein if said offer from said first shopper is not above a predetermined price;
notifying other eligible shoppers from the plurality of an auction for said item in inventory through said eligible shoppers' portable electronic device and receiving offers for the purchase of said item from the eligible shoppers of the plurality through said eligible shoppers' portable electronic device.

8. The system of claim 7 wherein said server transmits a counter offer to said first shopper through said synchronized portable electronic device, if the received offer is not above a predetermined price.

9. The system of claim 7 wherein said server sets a predetermined reserve price for said item being auctioned.

10. The system of claim 7 wherein said server records the customers' identity, item information, offer and transaction information in a storage medium for future use.

11. The system of claim 7 wherein if no offer is received for the purchase of said item from the eligible shoppers of the plurality above a predetermined price, authorizing the sales transaction with said first shopper.

12. A computer program product comprising a computer useable medium including computer usable program code for hosting an in-store electronic auction, said computer program product including;
computer usable program code for identifying the shoppers in a predetermined geographical area;
computer usable program code for determining a shopper's eligibility to participate in the auction;
computer usable program code for synchronizing a shopper's portable electronic device to a store server;
computer usable program code for receiving an offer for the purchase of an item in inventory from a first eligible shopper, placed through said shopper's portable electronic device,
computer usable program code for determining if a first shopper's offer for the item in inventory is above a predetermined price,
if the received offer is above a predetermined price, authorizing the sales transaction;
if the received offer is not above a predetermined price;
computer usable program code for notifying other eligible shoppers from the plurality of an auction for said item in inventory through said eligible shoppers' portable electronic device.

13. The computer program product of claim 12 further comprising computer useable program code for receiving offers for the purchase of said item from the eligible shoppers of the plurality through said eligible shoppers' portable electronic device.

14. The computer program product of claim 12 further comprising computer useable program code for authorizing the sales transaction with said first shopper if no offer is received for the purchase of said item from the eligible shoppers of the plurality above said predetermined price.
